(19) United States
(12) Patent Application Publication
(10) Pub. No.: US 2009/0288776 A1
(43) Pub. Date: Nov. 26, 2009

(54) HAND-HELD PRINTER

(75) Inventors: Toshiharu SHIMOSATO, Shizuoka (JP); Kazuaki SUGIMOTO, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: Toshiba Tec Kabushiki Kaisha, Tokyo (JP)

(21) Appl. No.: 12/402,661

(22) Filed: Mar. 12, 2009

(30) Foreign Application Priority Data
May 20, 2008 (JP) P2008-131546
May 20, 2008 (JP) P2008-131547

(51) Int. Cl. B32B 38/14

(52) U.S. Cl. 156/499

(57) ABSTRACT

A receptacle section stores a label. A label discharge port is positioned at a front end portion of a housing to let the label pass therethrough. A guide passage connects the receptacle portion and the label discharge port with each other and guides the label. A conveyance mechanism conveys the label along the guide passage from the receptacle section and discharges it through the label discharge port. A control section controls a drive source of the conveyance mechanism. A printing section performs a printing operation in the guide passage. A pivotable member is positioned in the label discharge port. One end of the pivotable member is located outside the front end portion of the housing, while an opposite end thereof is located inside the front end portion of the housing, and the pivotable member pivots, centered on an axis thereof extending in the width direction of the label discharged through the label discharge port. A label pressing section is positioned on the one end side of the pivotable member to press the label discharged through the label discharge port against a to-be-labeled object. A label cutting section is positioned on the opposite end side of the pivotable member, and with a pivoting motion of the pivotable member induced by the pressing motion of the label pressing section, the label cutting section comes into abutment against the label to form a slit in the label.

### CROSS-REFERENCE TO RELATED APPLICATION

This application is based upon and claims the benefit of priority from Japanese Patent Application No. 2008-131546, filed on May 20, 2008 and Japanese Patent Application No. 2008-131547, filed on May 20, 2008, the entire contents of which are incorporated herein by reference.

### TECHNICAL FIELD

The present invention relates to a hand-held printer.

### BACKGROUND

Heretofore there has been a portable printer which prints and issues information onto a label (see JP-A No. 2002-2058). A user uses the printer, for example, in a distribution center which sorts goods gathering from various places to destinations. In this case, the printer prints and issues information on destinations for example. The user sticks issued labels on goods.

Recently, from the standpoint of ecology, printer users in many cases use a linerless label which does not require recovery and disposal of a linear (release sheet).

Since the linerless label does not stick as an individual label onto a release sheet, it is necessary for the printer user to manually cut the issued label. To meet this requirement, the printer is provided at a label discharge port with, for example, a tier cutting type blade. The printer user cuts, at an appropriate length, the linerless label discharged through the label discharge port into individual labels and sticks each individual label on a to-be-labeled object.

Thus, the printer user performs both the linerless label cutting work and the work of sticking the cut, individual label onto a to-be-labeled object. However, performing such works entirely different in operation is very troublesome.

### SUMMARY

It is an object of the present invention to make it possible to perform both the label cutting work and the work of sticking each cut, individual label onto a to-be-labeled object as a series of operations.

In one aspect of the present invention there is provided a hand-held printer including a housing, a receptacle section for storing a label, a label discharge port positioned at a front end portion of the housing to let the label pass therethrough, a guide passage providing connection between the receptacle section and the label discharge port and guiding the label, a conveyance mechanism for conveying the label along the guide passage from the receptacle section and discharging it through the label discharge port, a control section for controlling a drive source of the conveyance mechanism, a printing section for performing a printing operation in the guide passage, a pivotable member positioned in the label discharge port and adapted to pivot, centered on an axis thereof extending in the width direction of the label discharged through the label discharge port, one end of the pivotable member being positioned outside the front end portion of the housing and an opposite end thereof being positioned inside the front end portion of the housing, a label pressing section positioned on one end side of the pivotable member and pressing the label discharged through the label discharge port against a to-be-labeled object, and a label cutting section positioned on the opposite end side of the pivotable member and adapted to strike against the label with a pivoting motion of the pivotable member induced by the pressing motion of the label pressing section to form a slit in the label.

In another aspect of the present invention there is provided a hand-held printer including a receptacle section for storing a linerless label having perforations, a label discharge port positioned at a front end portion of the housing to let the label pass therethrough, a guide passage providing connection between the receptacle section and the label discharge port and guiding the label, a conveyance mechanism for conveying the label along the guide passage from the receptacle section and discharging it through the label discharge port, a printing section for performing a printing operation in the guide passage, a control section for controlling a drive source of the conveyance mechanism so that the perforations of the linerless label discharged through the label discharge port are located at a position on a downstream side with respect to the printing section in the guide passage, a locking mechanism for locking the linerless label undrawably through the label discharge port, the linerless label being discharged through the label discharge port and with its perforations located at the perforation position, a label pressing section positioned outside the front end portion of the housing and on an upper surface side of the label discharge port, the label pressing section pressing the linerless label discharged through the label discharge port against a to-be-labeled object and imparting a longitudinal tension to the linerless label by movement along the pressed linerless label, and a label cutting section disposed in the width direction of the linerless label discharged through the label discharge port, the label cutting section interfering with the perforation position in the guide passage from an upper surface side and having a pointed shape in the interfering direction, with a vertex portion thereof being adapted to strike against perforations of the linerless label on which the label pressing section exerts a tension to form a slit in the linerless label and with an oblique side portion thereof contiguous to the vertex portion being adapted to subsequently strike against unslit perforations adjacent to the slit perforations to expand the slit.

In a further aspect of the present invention there is provided a hand-held printer including a housing, a receptacle section for storing a label, a label discharge port positioned at a front end portion of the housing to let the label pass therethrough, a guide passage providing connection between the receptacle section and the label discharge port and guiding the label, a conveyance mechanism for conveying the label along the guide passage from the receptacle portion and discharging it through the label discharge port, a printing section for performing a printing operation in the guide passage, a label pressing section positioned on an upper surface side of the label discharge port and outside the front end portion of the housing and pressing the label discharged through the label discharge port against a to-be-labeled object, a label pressing detecting section for detecting that the label pressing section has pressed the label discharged through the label discharge port and outputting the result of the detection, a label cutting section positioned on the upper surface side of the label discharge port and inside the front end portion of the housing, the label cutting section being able to enter the guide passage and striking against the label in the course of the entry into the guide passage to form a slit in the label, and a control section for controlling a drive source of the label cutting section in accordance with the detection output of the label pressing detecting section to make the label cutting section enter the guide passage.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view showing an appearance of a hand-held printer according to an embodiment of the present invention;

FIG. 2 is a right side view of the hand-held printer with part of a housing being broken away;

FIG. 3 is a perspective view showing a linerless label;

FIG. 4 is a side view in longitudinal section showing the environs of a label discharge port;

FIG. 5 is a perspective view showing a pivotable member;

FIG. 6 is a block diagram showing an electrical connection of the hand-held printer;

FIG. 7 is a flow chart showing a flow of processing carried out by a CPU in the hand-held printer;

FIG. 8A is a side view in longitudinal section showing a front end portion of the hand-held printer in a state in which a label is being stuck on a to-be-labeled article;

FIG. 8B is a side view in longitudinal section showing the front end portion of the hand-held printer in a state in which the label is being stuck on the to-be-labeled object;

FIG. 8C is a side view in longitudinal section showing the front end portion of the hand-held printer in a state in which the label is being stuck on the to-be-labeled object;

FIG. 9 is a schematic diagram showing a label cutting section;

FIG. 10 is a sectional view in longitudinal section showing a hand-held printer according to another embodiment of the present invention;

FIG. 11 is a schematic diagram showing a label cutting section;

FIG. 12 is a side view in longitudinal section showing a hand-held printer according to a further embodiment of the present invention;

FIG. 13 is a schematic diagram showing a label cutting section;

FIG. 14 is a side view in longitudinal section showing a hand-held printer according to a still further embodiment of the present invention;

FIG. 15 is a plan view showing a label cutting section schematically;

FIG. 16 is a side view in longitudinal section showing the environs of a label discharge port;

FIG. 17 is a perspective view showing a pivotable member;

FIG. 18 is a front view showing schematically a solenoid having a label cutting section;

FIG. 19 is a block diagram showing an electrical connection of the hand-held printer;

FIG. 20A is a side view in longitudinal section showing a front end portion of the hand-held printer in a state in which a label is being stuck on a to-be-labeled object;

FIG. 20B is a side view in longitudinal section showing the front end portion of the hand-held printer in a state in which the label is being stuck on the to-be-labeled object;

FIG. 20C is a side view in longitudinal section showing the front end portion of the hand-held printer in a state in which the label is being stuck on the to-be-labeled object;

FIG. 21 is a flow chart showing a flow of processing carried out by a CPU in label sticking and cutting;

FIG. 22 is a flow chart showing another example of a flow of processing carried out by the CPU in label sticking and cutting;

FIG. 23 is a schematic diagram showing a data structure of RAM;

FIG. 24 is a schematic diagram showing a label cutting section;

FIG. 25 is a side view in longitudinal section showing a hand-held printer according to a still further embodiment of the present invention;

FIG. 26 is a schematic diagram showing a label cutting section;

FIG. 27 is a side view in longitudinal section showing a hand-held printer according to a still further embodiment of the present invention; and

FIG. 28 is a schematic diagram showing a label cutting section.

### DETAILED DESCRIPTION

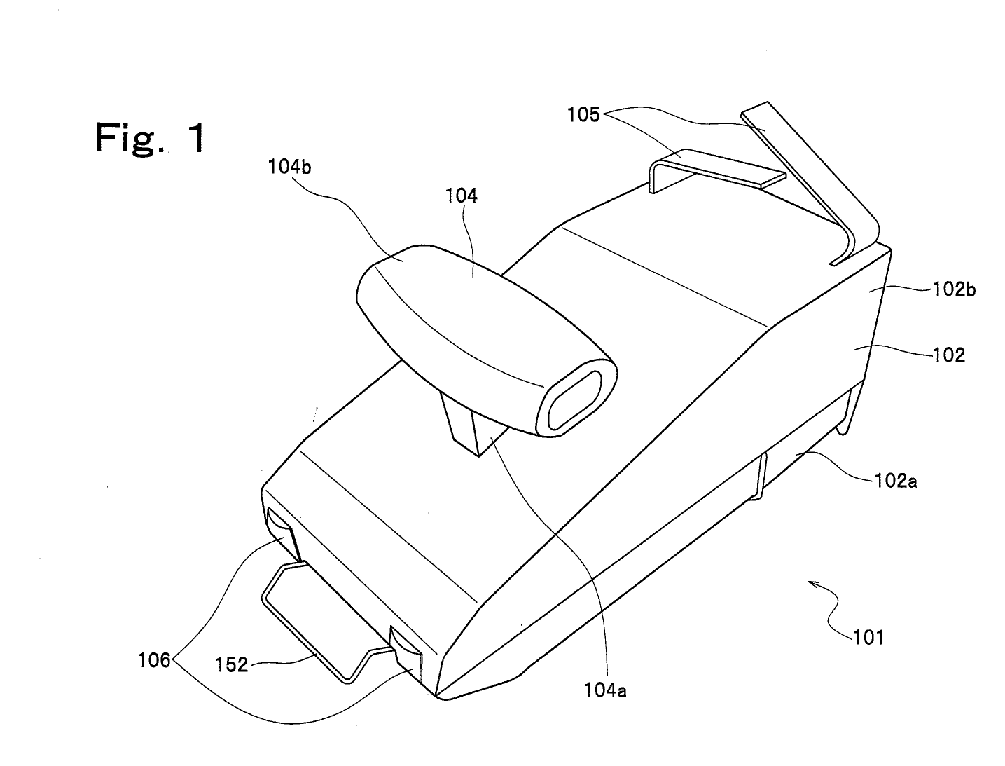

Embodiments of the present invention will be described below with reference to FIGS. 1 to 28.

FIG. 1 is a perspective view showing an appearance of a hand-held printer 101 according to an embodiment of the present invention. The hand-held printer 101 has a housing 102. The housing 102 is long in one direction and is inclined in such a manner that a part of its upper surface becomes lower toward a front side (the left lower side in FIG. 1).

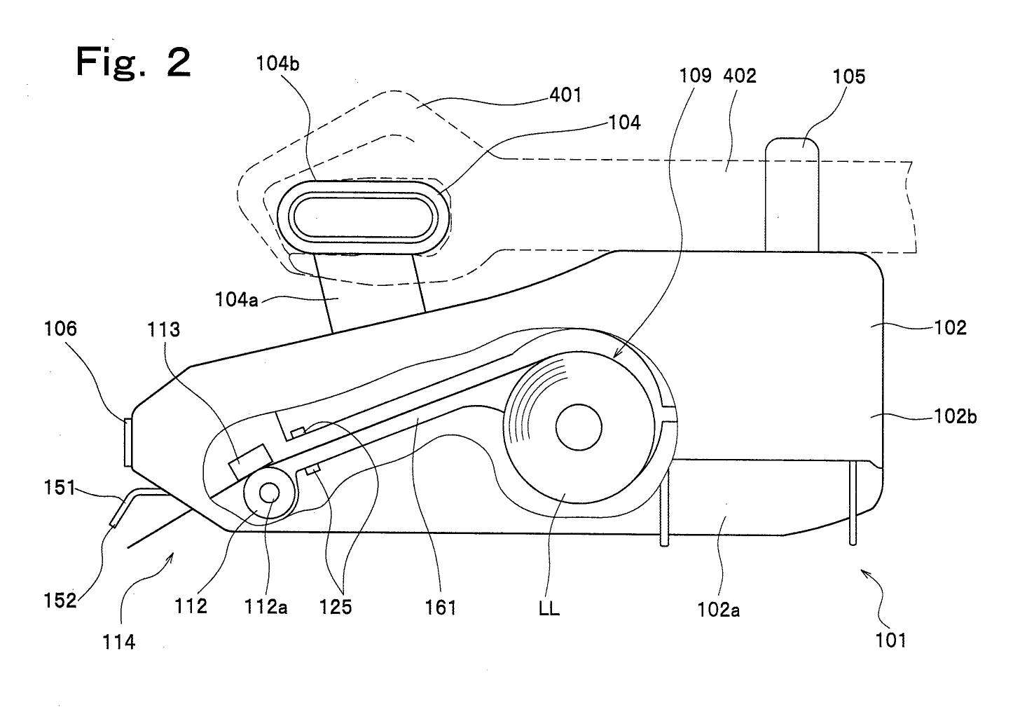

The housing 102 has a grip portion 104 in the front area of its upper surface. The front portion 104 has a support rod 104a whose lower end is fixed to the housing 102 and a flat body 104b connected to an upper end of the support rod 104a. The upper end portion of the support rod 104a is slightly inclined forward of the housing 102 (see FIG. 2). The flat body 104b has a flat columnar shape whose body portion bulges. Since the grip portion 104 is T-shaped, a user of the hand-held printer can grasp the grip portion 104 with one hand (right or left hand) (see FIG. 2).

The housing 102 has a pair of face fasteners 105 fixedly at a rear end of its upper surface. The face fasteners 105 each have a length such that they can wind around the user's arm the hand of which grasps the grip portion 104 and can stick to each other in this state.

FIG. 2 is a right side view of the hand-held printer 101 with a part of the housing 102 being broken away. By moving an arm 402 fixed-by the face fasteners 105, in the grasped state of the grip portion 104 with a hand 401, the hand-held printer 101 moves easily.

Since the upper surface of the housing 102 is inclined, the housing has a tapered shape when seen sideways, as shown in FIG. 2. This tapered end portion of the housing 102 may sometimes be referred to below as the “tip portion.” That is, when the hand-held printer 101 is seen from its upper surface side, the tip portion of the housing 102 is positioned on an extension line of the arm 402 passing through the hand 401 which grasps the grip portion 104. A lower surface of the housing 102 also has such a shape as gradually rises at the tip portion. In this gradually rising portion of the lower surface tip the housing 102 has a label discharge port 114 formed through the housing 102.

The housing 102 is made up of a lower unit 102a as a lower portion having the label discharge port 114, etc. and an upper unit 102b as an upper portion having the grip portion 104, etc. The upper unit 102b is adapted to pivot for opening and closing with respect to the lower unit 102a about a shaft (not shown) as a fulcrum which is positioned on a rear side (the right side in FIG. 2) of the lower unit 102a. The housing 102 is provided on a front face thereof with a pawl portion 106 for locking the lower unit 102a and the upper unit 102b in a closed state.

The housing 102 is provided in the interior thereof with a receptacle section 109 for storing a roll-like linerless label LL.

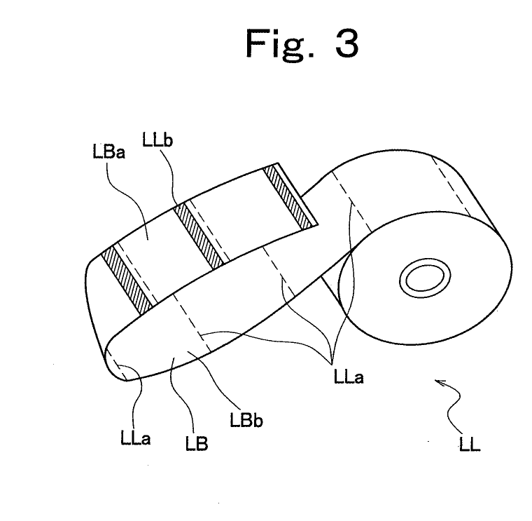

FIG. 3 is a perspective view showing the linerless label LL. The linerless label LL, which does not require a release sheet, is formed with perforations LLa at predetermined certain intervals. Each portion partitioned by adjacent perforations LLa is an individual label LB. Each label LB has an adhesive surface LBa with an adhesive applied thereto and a printing surface LBb which develops color on heating. A release agent is applied to the printing surface LBb.

Black lines LLb extending throughout the full width of the linerless label LL are printed beforehand on the adhesive surface LBa. At each label LB, each line LLb extends along perforations LLa at a position adjacent to the perforations LLa which are a partition from the immediately adjacent label LB on the front end side.

The receptacle section 109 stores the roll-like linerless label LL with the adhesive surface LBa facing inside.

Referring back to FIG. 2, the receptacle section 109 is formed by both lower unit 102a and upper unit 102b. The receptacle section 109 supports the bottom of the roll-like linerless label LL. By drawing out one end of the linerless label LL stored in the receptacle section 109, the label LL rotates.

As shown in FIG. 2, the housing 102 is formed in the interior thereof with a guide passage 161 for guiding the linerless label LL drawn out from the receptacle section 109 to the label discharge portion 114.

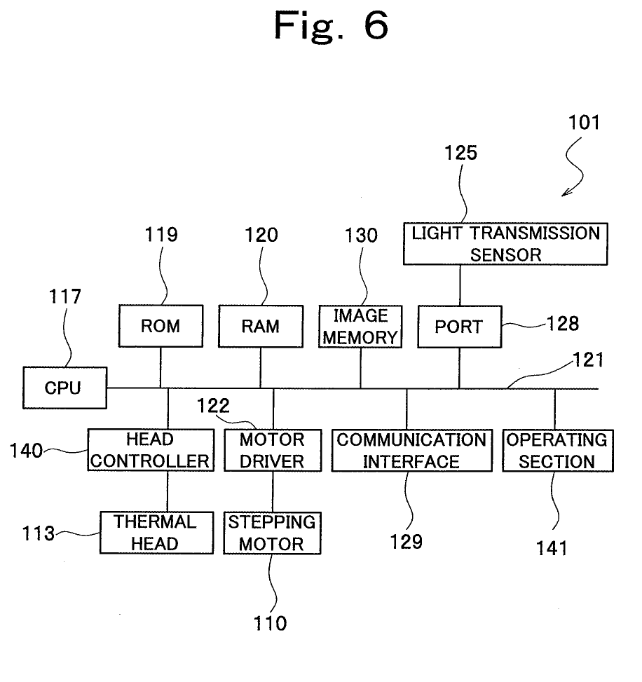

At a suitable position in the guide passage 161 there are disposed a pair of light transmission sensors 125, which are opposed to each other with the guide passage 161 therebetween. The light transmission sensors 125 are embedded in both lower unit 102a and upper unit 102b. A detection output from the light transmission sensors 125 is inputted to a CPU 117 (see FIG. 6).

When a line LLb passes between the light transmission sensors 125 during conveyance of the linerless label LL, the line LLb cuts off the transmission light between the light transmission sensors 125. On the other hand, while the other portion than the printed portion of the line LLb passes between the light transmission sensors 125, the other portion than the line printed portion does not cut off the transmission of light between both sensors. Upon cutoff of light, the detection output inputted from the light transmission sensor 126 to the CPU 117 changes from “high” to “low,” while upon transmission of light, it returns from “low” to “high.”

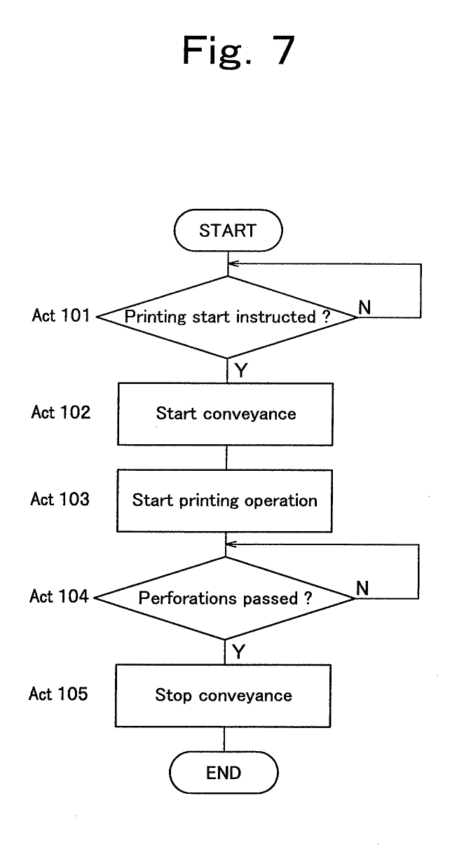

The perforations LLa of the linerless label LL are adjacent to the black lines LLb respectively (see FIG. 3). Therefore, when the transmission of light between the light transmission sensors 125 is cut off upon passage of a line LLb, it is regarded that the passage of the associated perforations LLa was detected by the light transmission sensors 125. The CPU 117 determines the passage of the perforations LLa on the basis of a change in detection output provided from the light transmission sensors 125 upon cutoff of light (see FIG. 7).

As shown in FIG. 2, a platen 112 as a conveyance mechanism which is driven for rotation and a thermal head 113 are disposed in opposition to each other on the front side of the housing 102. A rotational force of a stepping motor 110 (see FIG. 6) installed within the housing 102 is transmitted to a platen shaft 112a to rotate the platen 112. The thermal head causes heat generating elements (not shown) arranged line-like to come into abutment against the platen 112.

The lower unit 102a supports the platen shaft 112a of the platen 112 pivotably. The thermal head 113 is attached to the upper unit 102b. The thermal head 113 moves away from the platen 112 by opening the upper unit 102b with respect to the lower unit 102a.

In an opened state of the upper unit 102b, the roll-like linerless label LL is stored within the receptacle section 109, then the linerless label LL thus stored is drawn out and is put onto the platen 112. Thereafter, the upper unit 102b is again closed and is locked with the pawl portion 106. As a result, the platen 112 and the thermal head 113 hold the linerless label LL grippingly.

The linerless label LL thus held grippingly by both platen 112 and thermal head 113 is conveyed toward the front end side of the housing 102 by means of the platen 112 which is driven for rotation. In the course of the conveyance of the linerless label LL the heat generating element of the thermal head 113 which is driven to generate heat makes printing on the printing surface LBb.

The label discharge port 114 is wider than the linerless label LL. The linerless label LL conveyed by the platen 112 is guided to the label discharge port 114. The label discharge port 114 causes the linerless label LL to pass therethrough and discharges it to the exterior of the housing 102.

The linerless label LL discharged through the label discharge port 114 is cut into individual labels LB as will be described later. In the following description, therefore, as to the linerless label LL being discharged through the label discharge port 114, it may sometimes be referred to simply as “label LB” even if it has not been cut yet and is continuous with the roll-like linerless label LL stored in the receptacle section 109.

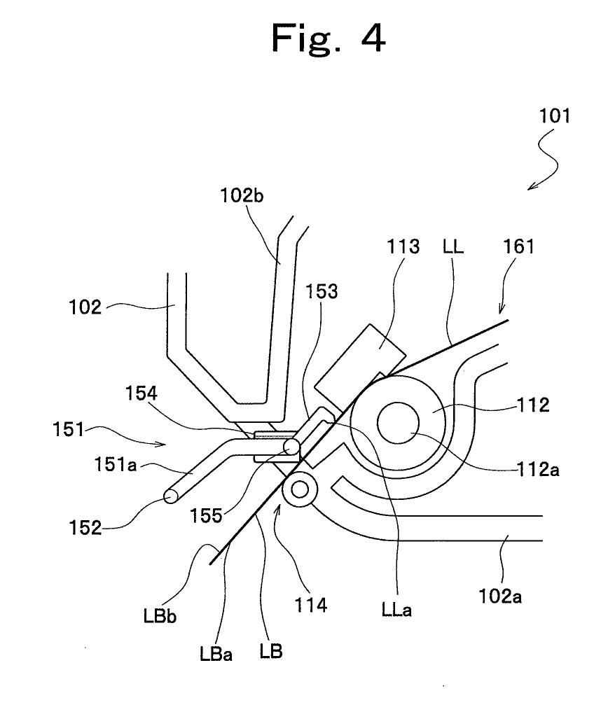

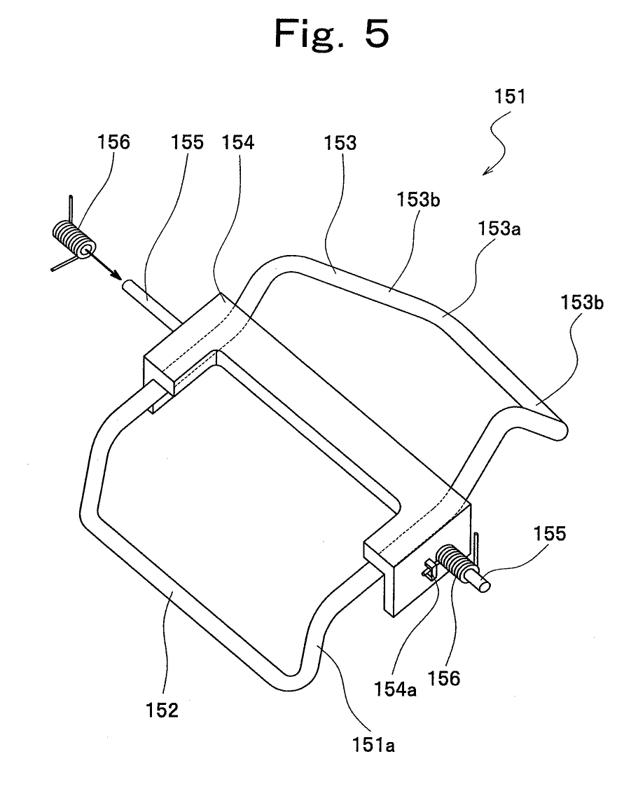

In the hand-held printer 101, a pivotable member 151 is disposed in the label discharge port 114. The pivotable member 151 will be described below with reference to FIGS. 4 and 5.

FIG. 4 is a side view in longitudinal section showing the environs of the label discharge port 114. FIG. 5 is a perspective view showing the pivotable member 151. The pivotable member 151 is positioned in the printing surface LBb-side area of the linerless label LL. The pivotable member 151 is pivotable with pivot shafts 155 as fulcrums which are parallel to the platen shaft 112a serving as a fulcrum of the platen 112.

As shown in FIG. 5, a main component of the pivotable member 151 is a round bar-like frame 151a having a transverse length somewhat narrower than the width of the linerless label LL. The frame 151a has such as shape as a bent rectangular frame. A look at the frame 151a sideways shows that a central part is a valley bend and both end sides are inverted V bends, as shown in FIG. 4. One side of the frame 151a is in a bend-free linear shape, as shown in FIG. 5. This linear side of the frame 151a is designated a label pressing section 152. The opposite side of the frame 151 is in a centrally pointed shape, having a vertex portion 153a and a pair of oblique side portions 153b contiguous to the vertex portion 153a. The centrally pointed opposite side of the frame 151a is designated a label cutting section 153.

As shown in FIG. 4, the label pressing section 152 is positioned outside the front end portion of the housing 102 and on the printing surface LBb side of the label LB discharged through the label discharge port 114.

The label cutting section 153 is positioned inside the front end portion of the housing 102 and on an upper surface side of the guide passage 161. More specifically, it is positioned between the thermal head 113 and the label discharge port 114 in the guide passage 161. As shown in FIG. 4, the label cutting section 153 extends in the width direction of the linerless label LL.

A frame cover 154 covers both side portions of the frame 151a which side portions connect the label pressing section 152 and the label cutting portion 153 with each other. The frame cover 154 is fixedly secured to the frame 151a. The pivot shafts 155 serving as fulcrums of the pivotable member 151 project respectively from both side faces of the frame cover 154. The lower unit 102a holds the pivot shafts 155 rotatably in a state in which torsion springs 156 are fitted on the shafts 155 (see FIG. 5). One ends of torsion springs 156 are inserted respectively into holes of holding portions 154a of the frame cover 154 and their positions are retained thereby. As to opposite ends of the torsion springs 156, though the details are not shown, they are inserted respectively into holes of holding portions (not shown) of the lower unit 102a and their positions are retained thereby, in a state in which the lower unit 102a holds the pivot shafts 155. Since both ends of each of the torsion springs 156 are thus fixed to the frame 151a and the lower unit 102a respectively, the pivotable member 151 with the pivot shafts 155 held as above is retained its position without freely moving in the turning direction of the pivot shafts 155. The torsion springs 156 are not shown in FIGS. 4, 8, 10 and 12.

If an external force is applied to the pivotable member 151 so as to lift the label pressing section 152, the pivotable member 151 pivots with the pivot shafts 155 as fulcrums so that the label cutting section 153 approaches the guide passage 161. The torsion springs 156 accumulate a repulsive force. Upon release of the external force exerted on the pivotable member 151, the torsion springs 156 which have accumulated the repulsive force revert to their original state. Consequently, the pivotable member 151 pivots with the pivot shafts 155 as fulcrums so that the label cutting section 153 moves away from the guide passage 161, and reverts to its original position.

If the label pressing section 152 is lifted continuously by applying an external force to the pivotable member 151, an upper surface of the frame cover 154 comes into abutment against an upper edge portion of the label discharge port 114, whereby the pivotal motion of the pivotable member 151 is inhibited. In this pivot-inhibited state of the pivotable member 151, the label cutting section 153 assumes an entering position into the guide passage 161 from the upper surface side.

The following description is now provided about an electrical connection of the hand-held printer 101.

FIG. 6 is a block diagram showing an electrical connection of the hand-held printer 101. The hand-held printer 101 includes the CPU 117 as a control section which controls various components concentratively while carrying out various arithmetic processings. A ROM 119 which stores fixed data fixedly and a RAM 120 which stores variable data rewritably are connected to the CPU 117 via a system bus 121. In accordance with a control program stored in the ROM 119 the CPU 117 executes various processings while utilizing the RAM 120 as a work area.

As components whose operations are controlled by the CPU 117, the hand-held printer 101 includes a motor driver 122 for controlling the operation of a stepping motor 110 which is for driving the platen 112 rotationally and a head controller 140 which causes heat generating elements (not shown) of the thermal head 113 to generate heat, allowing the thermal head 113 to perform a printing operation. The motor driver 122 and the head controller 140 are connected to the CPU 117 via the system bus 121.

A communication interface 129 and an image memory 130 are also connected to the CPU 117 via the system bus 121. The hand-held printer 101 receives printing data from a host device via the communication interface 129. The CPU 117 in the hand-held printer 101 converts the printing data into image data of a dot pattern and develops it in the image memory 130.

The CPU 117 outputs data line by line to the head controller 140 from the image data developed in the image memory 130. The head controller 140 causes the heat generating elements (not shown) corresponding to the dots of the dot pattern to generate heat. In this way the thermal head 113 performs a printing operation.

The housing 102 includes an operating section 141 for starting a printing operation. The operating section 141 is also connected to the CPU 117 via the system bus 121. With operation performed in the operating section 141, a printing start command is inputted to the CPU 117.

The light transmission sensors 125 for detecting a line LLb of the linerless label LL are connected to the system bus 121 via a port 128. The detection output provided from the light transmission sensors 125 is inputted to the CPU 117.

In such a construction, when the thermal head 113 makes printing on the printing surface LBb of the label LB and the label discharge port 114 discharges the label LB, the CPU 117 in the hand-held printer 101 executes the following processing.

FIG. 7 is a flow chart showing a flow of processing carried out by the CPU 117 in the hand-held printer 101. The CPU 117 in the hand-held printer 101 stands by until input of a printing start command (Act 101). When the CPU 117 determines that there has been an input of a printing start command by operation in the operating section 141 (Yes in Act 101), it drives the stepping motor 110 rotationally, causing the platen 112 to start conveyance of the linerless label LL (Act 102). At the same time, the CPU 117 controls the head controller 140 to let the thermal head 113 start printing (Act 103). The printing operation is completed upon output of data of all the lines from the image data developed in the image memory 130.

When a line LLb of the linerless label LL being conveyed is positioned between the light transmission sensors 125, the detection output inputted to the CPU 117 from the sensors 125 changes to “Low,” whereupon the CPU 117 determines that perforations LLa are passing (Yes in Act 104). Then, after the lapse of a predetermined time, the CUP 117 turns OFF the operation of the stepping motor 110 to stop the conveyance by the platen 112 (Act 105).

At a timing at which perforations LLa of the linerless label LL are located at a position (perforation position) on the pivoting path of the label cutting section 153 the CPU 117 executes the stop of conveyance (Act 105).

When the conveyance is stopped, the CPU 117 makes control to retain the rotational position of the stepping motor 110 by allowing an exciting current (driving current) to flow continuously in an excitation phase of the stepping motor 110. By retaining the rotational position of the stepping motor 110 the rotation of the platen 112 is also inhibited. The linerless label LL held grippingly by the platen 112 and the thermal head 113 is locked against conveyance and is not drawn out through the label discharge port 114 even if an external force is applied thereto. The platen 112 and the thermal head 113 constitute a locking mechanism which makes it impossible to draw out the linerless label LL.

In the conveyance-stopped state of Act 105 a part of the label LB partitioned by perforations LLa is exposed through the label discharge port 114 to the exterior of the housing 102 and is positioned under the label pressing portion 152.

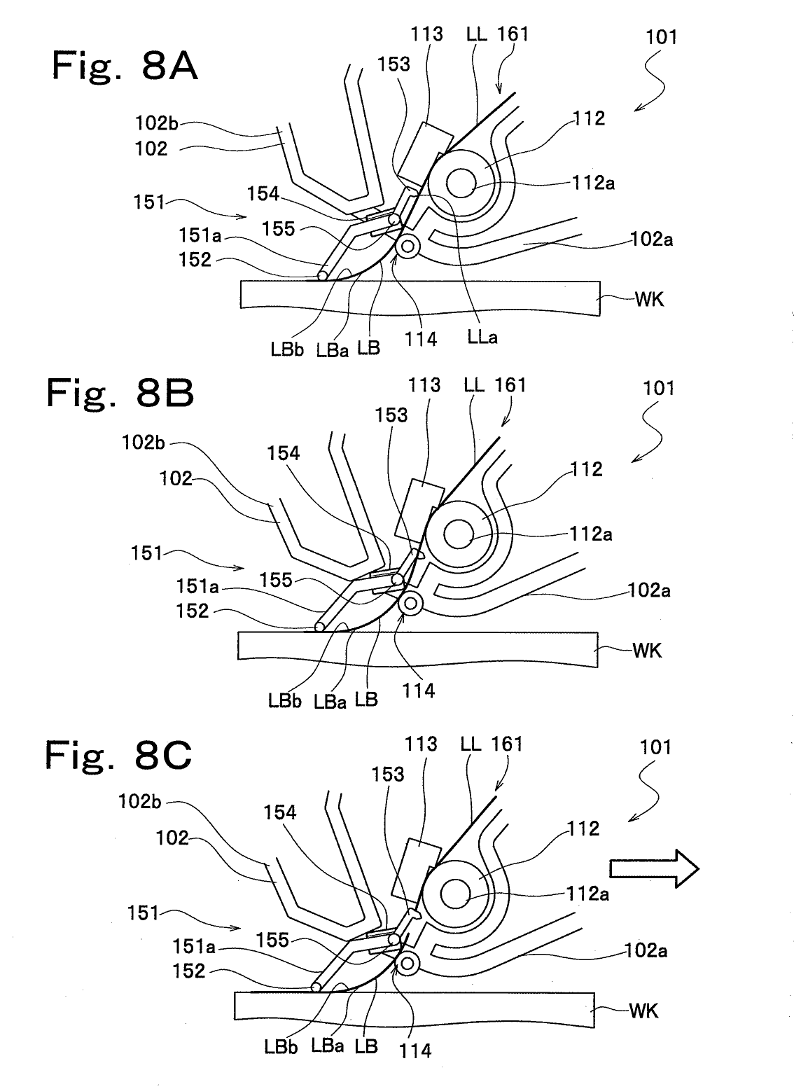

A description will now be given about the case where the label LB with a part thereof exposed through the label discharge port 114 is to be stuck on an upper surface of a to-be-labeled object WK (see FIG. 8).

FIG. 8 is a side view in longitudinal section showing a front end portion of the hand-held printer 101 in a state in which the label LB is being stuck on the to-be-labeled object WK. The user of the hand-held printer 101 grasps the grip portion 104 with his or her hand 401. The face fasteners 105 fix the user's arm 402 with respect to the housing 102.

First, the user of the hand-held printer 101 moves the arm 402 while grasping the grip portion 104 with hand 401 to bring the hand-held printer 101 into an attitude in which the label discharge port 114 faces downward. Next, the printer user causes the hand-held printer 101 with the label discharge port 114 facing downward to approach the to-be-labeled object WK. In this way, as shown in FIG. 8A, the front end of the adhesive surface LBa of the label LB being discharged through the label discharge port 114 comes into contact with the surface of the to-be-labeled object WK. The label pressing portion 152 comes into contact with the printing surface LBb on the side opposite to the adhesive surface LBa which is in contact with the to-be-labeled object WK.

Then, the user of the hand-held printer 101 pushes the hand-held printer 101 against the to-be-labeled object WK. In this case, since the label pressing section 152 presses the printing surface LBb, the adhesive surface LBa is put in contact with the to-be-labeled object WK more closely.

Under such a pressing motion, the pivotable member 151 including the label pressing section 152 undergoes an urging force from the to-be-labeled object WK, so that, with the pivot shafts 155 as fulcrums, the label pressing section 152 rises and the label cutting section 153 pivots so as to get into the guide passage 161, as shown in FIG. 8B. With the pivotal motion of the pivotable member 151, the torsion springs 156 accumulate a repulsive force.

Perforations LLa of the linerless label LL are positioned on the pivoting path of the pivotable member 153 (see Act 105 in the flow chart of FIG. 7). Therefore, when the label cutting section 153 gets into the guide passage 161 with the pivotal motion of the pivotable member 151, first the vertex portion 153a of the label cutting section 153 comes into abutment against the perforations LLa from the upper surface side. As a result, a dot-like slit based on the shape of the vertex potion 153a (see FIG. 5) is formed in the central part of the perforations LLa. As the label cutting section 153 further gets into the guide passage 161, the oblique side portions 153b contiguous to the vertex portion 153a gradually expand the slit along the perforations LLa. In this way there are formed slits extending to both sides from the central part.

Next, the user of the hand-held printer 101 moves the arm 402 while gripping the grip portion 104, whereby the hand-held printer 101 is moved like being pulled to the user side (rightward in FIG. 8) along the surface of the to-be-labeled object WK, as shown in FIG. 8C.

The adhesive surface LBa on the front end side of the label LB discharged through the label discharge port 114 adheres to the surface of the to-be-labeled object WK, whereby the position thereof is fixed. The thermal head 113 and the platen 112 which has stopped its rotation lock the linerless label LL including the label LB in an undrawable manner.

Therefore, by moving the hand-held printer 101 in a pulling direction along the surface of the to-be-labeled object WK, the linerless label LL including the label LB discharged through the label discharge port 114 is pulled from both end sides. Since the perforations LLa have the slits, the linerless label LL becomes untolerable against the pulling from both end sides as the hand-held printer 101 moves and is cut while allowing the label LB with its adhesive surface LBa bonded to the to-be-labeled object WK to remain.

Also after cutting the label LB the user of the hand-held printer 101 moves the printer while pulling the printer to the user side and while pressing down the printer against the to-be-labeled object WK. As a result, the label pressing section 152 presses the label LB against the to-be-labeled object WK while sliding on the printing surface LBb. Consequently, the adhesive surface LBa is sure to stick on the to-be-labeled object WK.

After sticking the label LB to the to-be-labeled object WK, the user of the hand-held printer 101 causes the printer to leave the object WK, relieving the pressing force of the label pressing section 152 against the label LB. As a result, the torsion springs 156 which have accumulated the repulsive force revert to their original state and hence the pivotable member 151 pivots with the pivot shafts 155 as fulcrums and returns to its original position.

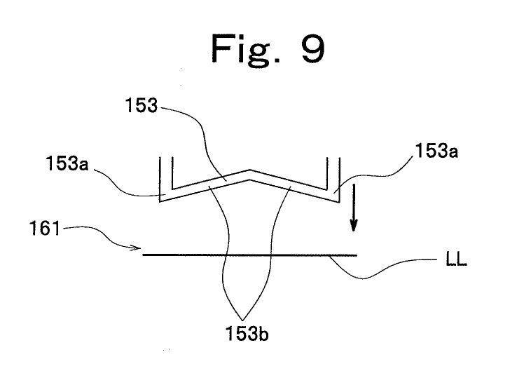

The shape of the label cutting section 153 is not limited to the shape described above in connection with FIG. 5. For example, it may be such a shape as shown in FIG. 9, in which the label cutting section 153 is depressed centrally with respect to the guide passage 161 and has vertex portions 153a at both side ends thereof. The label cutting section 153 has side portions 153b extending from the vertex portions 153a toward the central portion. First, the vertex portions 153a strike against perforations LLa from the upper surface side, whereby dot-like slits based on the shape of the vertex portions 153a are formed in both end portions of the perforations LLa. As the label cutting section 153 further gets into the guide passage 161, the oblique side portions 153b contiguous to the vertex portions 153a gradually expand the slits along the perforations LLa. In this way, slits extending from both end portions to the central part are formed in the perforations LLa.

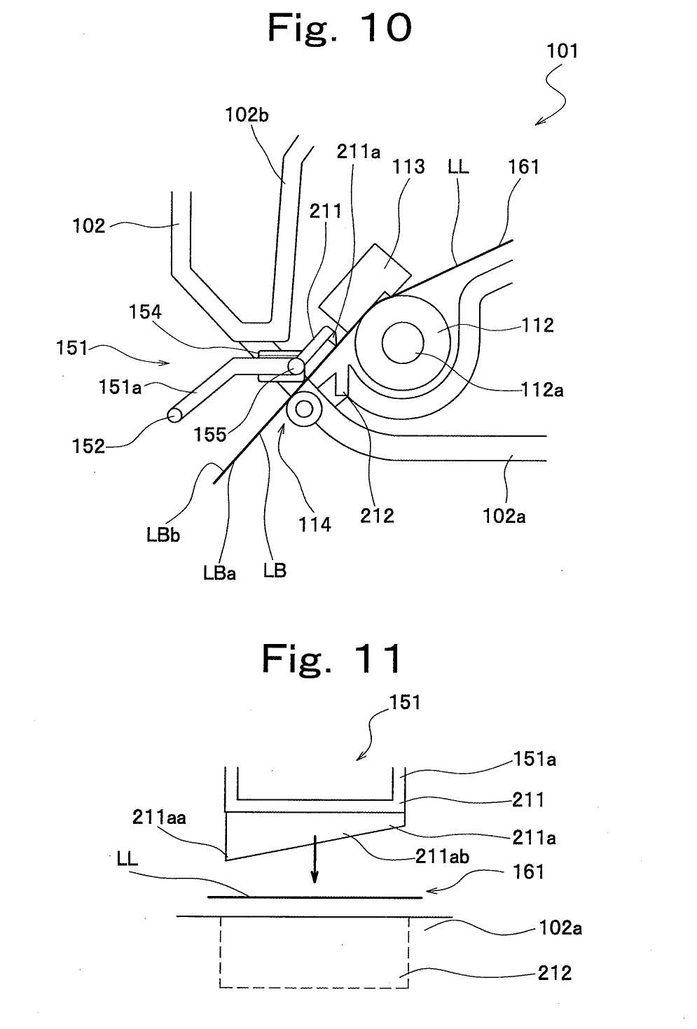

Next, with reference to FIGS. 10 and 11, a description will be given below about a hand-held printer 101 according to another embodiment of the present invention. As to the same portions as in FIGS. 1 to 8, they are identified by the same reference numerals as in those figures, and explanations thereof will be omitted (this is also true in subsequent embodiments).

FIG. 10 is a sectional view in longitudinal section of the hand-held printer 101. FIG. 11 is a schematic diagram showing a label cutting section 211. The label cutting section 211 includes a blade 211a fixed to the frame 151a. As shown in FIG. 10, the blade 211a is a sharp blade extending in the width direction of the linerless label LL and having a front end which is pointed at an acute angle when seen sideways. Further, as shown in FIG. 11, the blade 211a has a pointed shape toward the guide passage 161. More specifically, the blade 211a includes a vertex portion 211aa offset to one side of the guide passage 161 and an oblique side portion 211ab as an edge contiguous to the vertex portion 211aa.

As shown in FIG. 10, the hand-held printer 101 includes a receptacle slot 212 at a position opposed to the front end of the blade 211a through the guide passage 161, the receptacle slot 212 having a shape capable of receiving the blade 211a therein. The lower unit 102a forms the receptacle slot 212.

For sticking the label LB discharged through the label discharge port 114 onto the to-be-labeled object WK, the user of the hand-held printer 101 presses the hand-held printer 101 against the object WK in a state in which the label pressing section 152 is in contact with the printing surface LBb. As a result, the pivotable member 151 pivots under exertion thereon of a pressing force from the to-be-labeled object WK and the label cutting section 211 gets into the guide passage 161.

Upon entry of the label cutting section 211 into the guide passage 161, the blade 211a gets into the receptacle slot 212. First, the vertex portion 211aa of the blade 211a pierces the linerless label LL to form a slit. As the blade 211a further gets into the receptacle slot 212, the oblique side portion 211ab cuts the linerless label LL in the width direction to expand the slit. Since the blade 211a is shorter than the width of the linerless label LL, one or both ends of the linerless label LL are slit-free portions.

By moving the hand-held printer 101 in such a manner as pulling it to the user side along the surface of the to-be-labeled object WK, the label LB is cut completely from the slit.

Since the blade 211a breaks through the linerless label LL forcibly to form a slit, it is possible to form a slit also in the portion free from perforations LLa of the linerless label LL or in a linerless label LL free from perforations LLa.

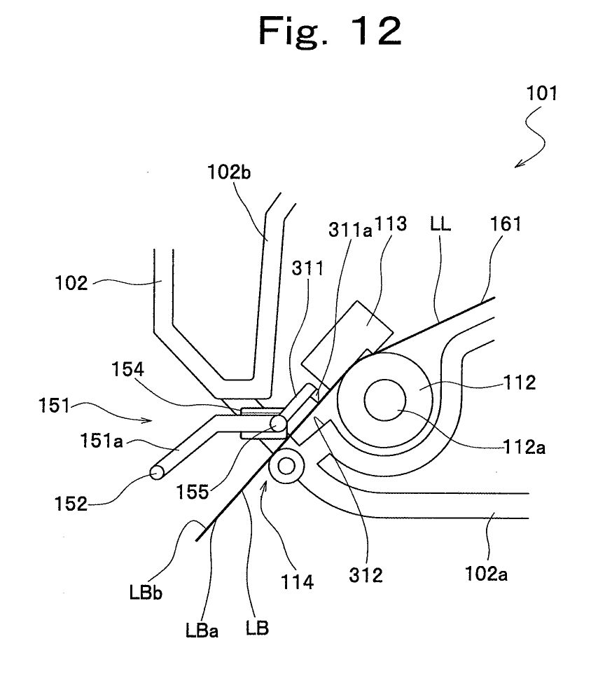

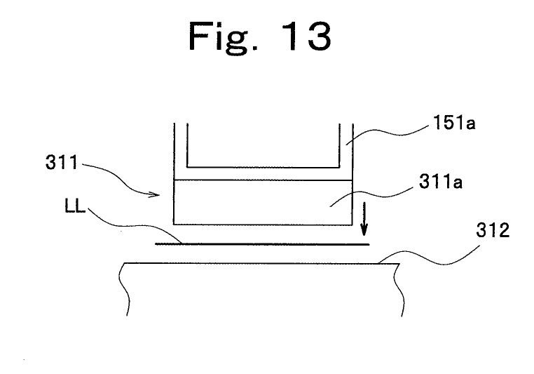

Next, with reference to FIGS. 12 and 13, a description will be given below about a hand-held printer 101 according to a further embodiment of the present invention.

FIG. 12 is a side view in longitudinal section showing the hand-held printer 101, and FIG. 13 is a schematic diagram showing a label cutting section 311. The label cutting section 311 includes a blade 311a having a front end which is pointed at an acute angle when seen sideways. The blade 311a is a side portion extending in the width direction of the linerless label LL guided by the guide passage 161 and in parallel with the label LL.

As shown in FIGS. 12 and 13, the hand-held printer 101 has an abutment surface 312 in the lower unit 102a at a position confronting the front end of the blade 311a. The abutment surface 312 has a shape matching the front end shape of the blade 311a, that is, the abutment surface 312 is parallel to the linerless label LL guided by the guide passage 161.

For sticking the label LB discharged through the label discharge port 114 onto the to-be-labeled object WK, the user of the hand-held printer 101 presses down the printer 101 against the to-be-labeled object WK in a state in which the label pressing section 152 is in contact with the printing surface LBb of the label LB discharged through the label discharge port 114. As a result, the pivotable member 151 pivots under exertion thereon of an urging force from the to-be-labeled object WK and the label cutting section 311 gets into the guide passage 161. Further, the blade 311a comes into abutment against the abutment surface 312.

Upon entry of the label cutting section 311 into the guide passage 161, the sharp blade 311a presses the linerless label LL present in the guide passage 161 against the abutment surface 312. As a result, the linerless label LL is cut along the blade 311a to form a slit in the width direction. Since the blade 311a is shorter than the width of the linerless label LL, one or both ends of the linerless label LL become slit-free portions.

Then, if the user moves the hand-held printer 101 while pulling the printer to the user side along the upper surface of the to-be-labeled object WK, the label is cut completely from the slit.

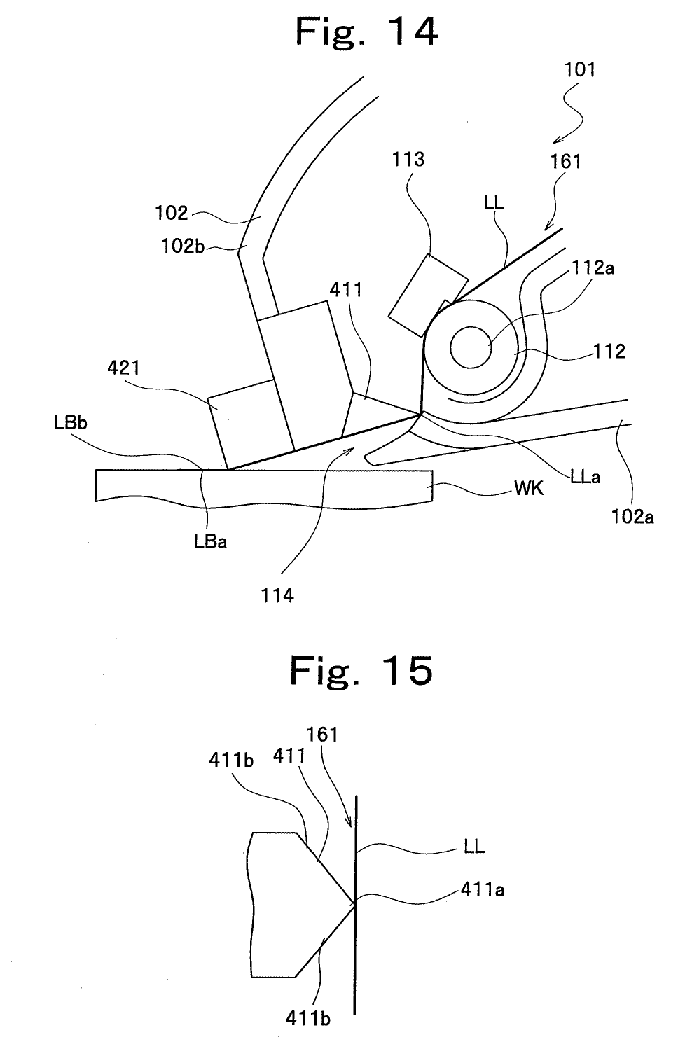

Next, with reference to FIGS. 14 and 15, a description will be given below about a hand-held printer 101 according to a still further embodiment of the present invention.

FIG. 14 is a side view in longitudinal section of the hand-held printer 101, showing a state in which a label LB is being stuck on the to-be-labeled object WK. FIG. 15 is a plan view showing a label cutting section 411 schematically.

The label cutting section 411 and a label pressing section 421 are secured to the upper unit 102b fixedly.

The label pressing section 421 is positioned outside the front end portion of the upper unit 102b and on the upper surface side of the label discharge port 114. The label pressing section 421 is in the shape of a quadrangular prism which is long in the width direction of the housing 102. The label pressing section 421 forms a rectilinear side.

The label cutting section 411 is positioned inside the front end portion of the upper unit 102b. As shown in FIG. 14, the label cutting section 411 has a projecting shape toward the guide passage 161 when seen sideways. As shown in FIG. 15, the label cutting section 411 is pointed at its central part when seen from its upper surface side. The label cutting section 411 has a vertex portion 411a and a pair of oblique side portions 411b contiguous to the vertex portion 411a.

A front end portion of the label cutting section 411, including the vertex portion 411a, interferes with the guide passage 161 and it comes into contact with the printing surface LBb of the linerless label LL which is guided by the guide passage 161 and discharged through the label discharge port 114.

While the conveyance of the linerless label LL stops ((Act 105 in the flow chart of FIG. 7), the perforations LLa of the linerless label LL assume a position (perforation position) where they are in contact with the vertex portion 411a of the label cutting section 411.

The following description is now provided about the case where the label LB discharged through the label discharge port 114 is to be stuck on the to-be-labeled object WK with use of the hand-held printer 101.

The thermal head 113 and the platen 112 lock the linerless label LL undrawably, the linerless label LL including the label LB discharged through the label discharge port 114.

With the label pressing section 421, the user of the hand-held printer 101 presses down the label LB discharged through the label discharge port 114. Then, the user moves the label pressing section 421 along the printing surface LBb of the label LB thus pressed down. In this way the label pressing section 421 sticks the adhesive surface LBa onto the to-be-labeled object WK.

In the course of the sticking operation, the label LB discharged through the label discharge port 114 is pulled in its longitudinal direction and assumes a tension-applied state.

As noted above, the front end portion of the label cutting section 411 interferes with the guide passage 161 and comes into contact with perforations LLa of the linerless label LL present in the guide passage 161. As a result, tension is applied to the linerless label LL, so that the linerless label LL is pushed against and along the front end portion of the label cutting section 411. First, the vertex portion 411a strikes against perforations LLa to form a dot-like slit. Thereafter, the side portions 411b strike against perforations LLa to expand the slit along the perforations. In this way there is formed a slit in the perforations LLa.

In the state in which the label LB is pressed down by the label pressing section 421, the user of the hand-held printer 101 moves the hand-held printer 101 while pulling the printer to the user side. As a result, the label LB is cut off completely from the perforations LLa in the course of the movement of the hand-held printer 101. Since the label pressing section 152 presses the label LB against the to-be-labeled object WK while sliding on the printing surface LBb, the adhesive surface LBa is sure to stick to the object WK.

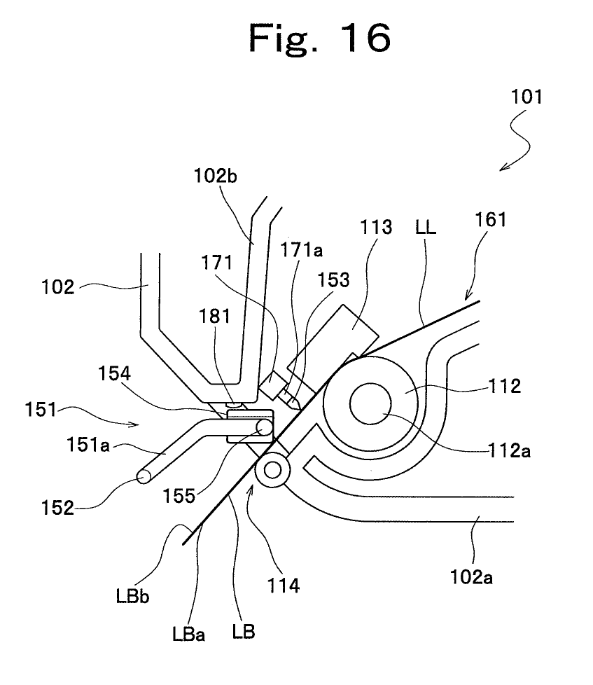

Next, with reference to FIGS. 16 to 23, a description will be given below about a hand-held printer 101 according to a still further embodiment of the present invention.

The hand-held printer 101 is provided in the label discharge port 114 with a pivotable member 151 having a label pressing section 152, a solenoid 171 having a label cutting section 153, and a pressure sensor 181, (for all of these see FIG. 16).

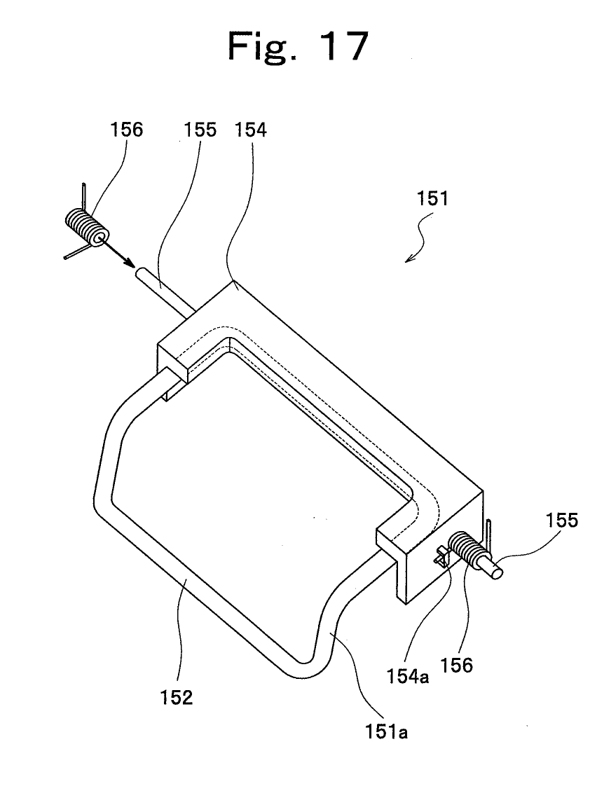

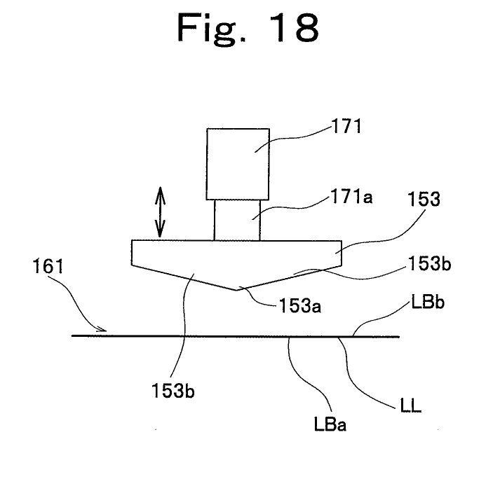

FIG. 16 is a side view in longitudinal section showing the environs of the label discharge port 114. FIG. 17 is a perspective view showing the pivotable member 151. FIG. 18 is a front view showing schematically the solenoid 171 having the label cutting section 153.

As shown in FIG. 16, the pivotable member 151 is positioned in the printing surface LBb-side area of the linerless label LL. The pivotable member 151 is pivotable with pivot shafts 155 as fulcrums which are parallel to the platen shaft 112a as a fulcrum of the platen 112.

As shown in FIG. 17, a main component of the pivotable member 151 is a round bar-like frame 151a. The frame 151a is in the shape of a bent rectangular frame. When the frame 151a is seen sideways, its central part is bent in an inverted V shape, as shown in FIG. 16. A rectilinear one side of the frame 151a is designated a label pressing section 152. The label pressing section 152 has a transverse length somewhat narrower than the width of the linerless label LL.

As shown in FIG. 16, the label pressing section 152 is positioned on the printing surface LBb side of the label LB discharged through the label discharge port 114.

Both ends of each of torsion springs 156 are fixed to the frame 151a and the lower unit 102a respectively, so while the pivot shafts 155 are held, the pivotable member 151 is held in position without freely moving in the turning direction of the pivot shafts 155. The torsion springs 156 are not shown in FIGS. 16, 20, 25 and 27.

If an external force is applied to the pivotable member 151 so as to raise the label pressing section 152, the pivotable member 151 displaces itself with the pivot shafts 155 as fulcrums. At this time, a repulsive force is accumulated in the torsion springs 156. Upon relief of the external force on the pivotable member 151, the torsion springs 156 which have accumulated the repulsive force revert to their original state, so that the pivotable member 151 displace itself with the pivot shafts 155 as fulcrums and revert to its original position.

As shown in FIG. 16, the pressure sensor 181 is attached to the upper edge portion of the label discharge port 114. The pressure sensor 181 incorporates a pressure sensing element to transform a change in air pressure into an electric signal.

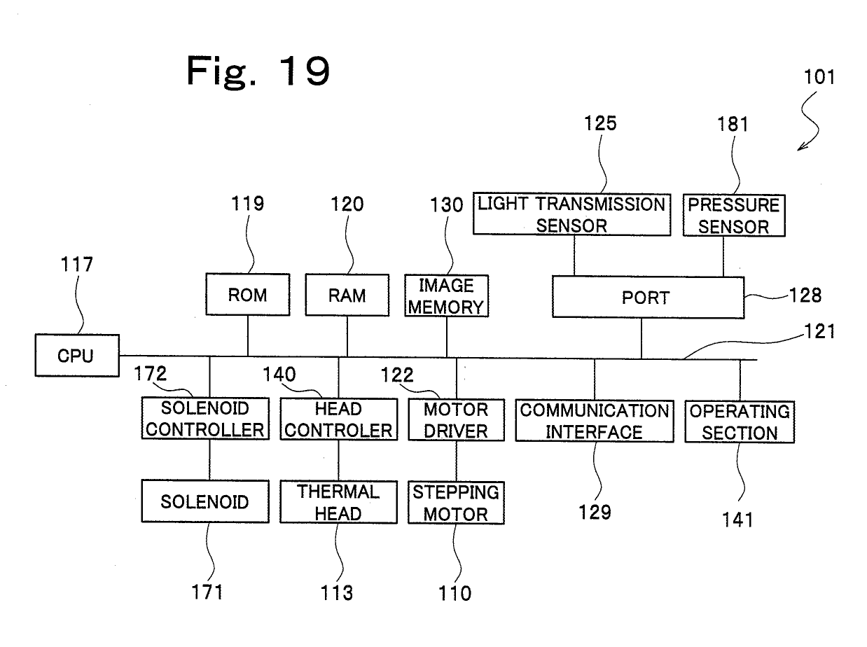

If the label pressing section 152 is kept raised by applying an external force to the pivotable member 151, the upper surface of the frame cover 154 comes into abutment against the pressure sensor 181, whereby the pivotal motion of the pivotable member 151 is inhibited. Upon abutment of the frame cover 154 against the pressure sensor 181, the air pressure in the pressure sensor 181 exceeds a preset pressure value. At this instant the pressure sensor 181 outputs an electric signal to a CPU 117 (see FIG. 19).

As shown in FIG. 16, the hand-held printer 101 has a solenoid 171 in the interior of the housing 102. The solenoid 171 is positioned more downstream of the guide passage 161 than the thermal head 113 and on the upper surface side of the guide passage. The solenoid 171 causes a movable shaft 171a to extend and retract with respect to the guide passage 161.

As shown in FIG. 18, the solenoid 171 is fixedly provided at a tip of the movable shaft 171a with a label cutting section 153 having a shape such that a central part is pointed toward the guide passage 161. More specifically, the label cutting section 153 has a central vertex portion 153a and a pair of oblique side portions 153b contiguous to the vertex portion 153a.

As the movable shaft 171a of the solenoid 171 extends, the label cutting section 153 gets into the guide passage 161 from the upper surface side. The tip of the label cutting section 153 including the vertex portion 153a strikes against the linerless label LL. When the movable shaft 171a of the solenoid 171 retracts, the label cutting section 153 retracts from the guide passage 161 and is thus no longer present in the guide passage 161.

The following description is now provided about an electrical connection of the hand-held printer 101.

FIG. 19 is a block diagram showing an electrical connection of the hand-held printer 101. The hand-held printer 101 has a solenoid controller 172 for activating the solenoid 171 to displace the movable shaft 171a. The solenoid controller 172 is connected to a CPU 117 via a system bus 121.

The pressure sensor 181 is connected to the system bus 121 via a port 128. A detection output from the pressure sensor 181 is inputted to the CPU 117.

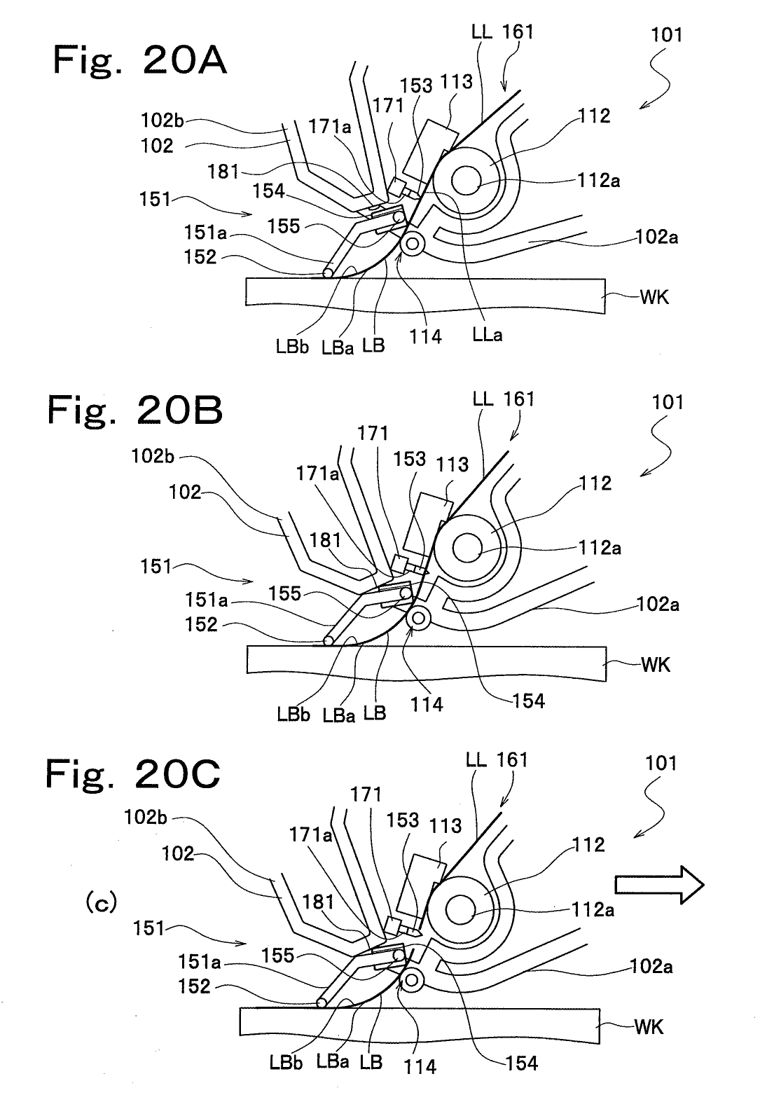

Description is now directed to a case where a label LB exposed partially through the label discharge port 114 is to be stuck on an upper surface of the to-be-labeled object WK (see FIG. 20).

FIG. 20 is a side view in longitudinal section showing a front end portion of the hand-held printer 101 in a state in which a label LB is being stuck on the to-be-labeled object WK.

The user of the hand-held printer 101 exerts an external force on the printer 101 to press down the printer 101 against the to-be-labeled object WK in a state in which the label pressing section 152 is in contact with the printing surface LBb. Since the label pressing section 152 thus presses down the printing surface LBb, the adhesive surface LBa comes into contact more closely with the to-be-labeled object WK.

Under such a pressing motion, the pivotable member 151 including the label pressing section 152 undergoes an urging force from the to-be-labeled object WK and pivotally displaces itself with the pivot shafts 155 as fulcrums so that the label pressing section 152 rises, as shown in FIG. 20B. By the pivotal displacement of the pivotable member 151 the torsion springs 156 accumulate a repulsive force.

The displacement of the pivotable member 151 causes the frame cover 154 to come into abutment against the pressure sensor 181, as shown in FIG. 20B. The moment the frame cover 154 is abutted against the pressure sensor 181, it is determined that the pressure sensor 181 has detected a pressed-down condition of the label LB by the label pressing section 152. Thus, the pressure sensor 181 functions as a label pressing detecting section.

The pressure sensor 181 outputs an electric signal, which is inputted to the CPU 117. With this electric signal, the CPU 117 determines that the label pressing section 152 has pressed down the label LB.

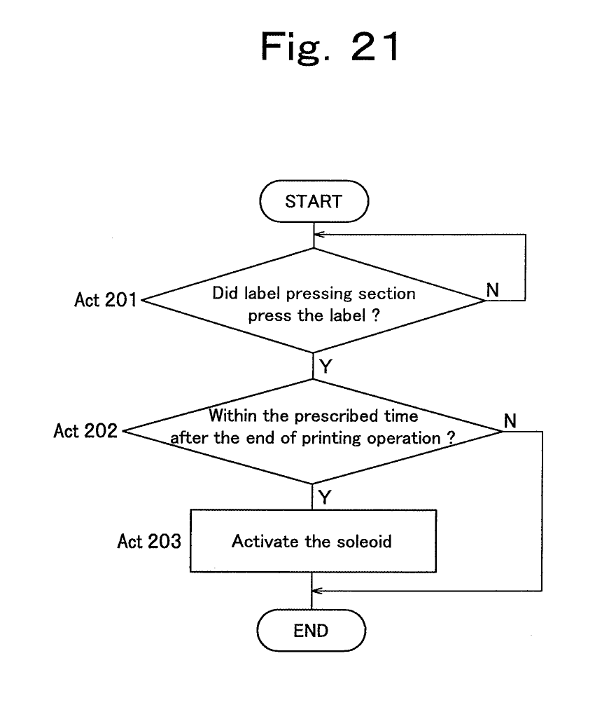

FIG. 21 is a flow chart showing a flow of processing which the CPU 117 carries out for sticking and cutting the label LB. After having determined the pressed-down condition of the label LB by the label pressing section 152 on the basis of the output provided from the pressure sensor 181 (Yes in Act 201), the CPU 117 determines whether the time elapsed after the end of the printing operation by the thermal head 113 is within a prescribed time or not (Act 202). If the prescribed time has elapsed after the end of the printing operation (No in Act 202), the CPU 117 terminates the processing.

On the other hand, if the elapsed time is within the prescribed time (Yes in Act 202), the CPU 117 activates the solenoid 171 via the solenoid controller 172 to displace the movable shaft 171a. That is, after bringing the movable shaft 171a once into an extended state after its retracted state, the CPU 117 again restores the movable shaft 171a to the retracted state (Act 203).

Referring back to FIG. 20, when the movable shaft 171a of the solenoid 171 is in an extended state, the label cutting section 153 gets into the guide passage 161, as shown in FIG. 20B. At this time, perforations LLa of the linerless label LL are positioned on the displacement path of the label cutting section 153 (see Act 105 in the flow chart of FIG. 7).

Upon entry of the label cutting section 153 into the guide passage 161, first the vertex portion 153a of the label cutting section 153 strikes against the perforations LLa from the upper surface side. As a result, the central part of the perforations LLa forms a dot-like slit based on the shape of the vertex portion 153a (see FIG. 18). As the label cutting section 153 further gets into the guide passage 161, the oblique side portions 153b contiguous to the vertex portion 153a gradually expands the slit along the perforations LLa. In this way, slits extending to both sides from the central part are formed along the perforations.

In the case where the frame cover 154 comes into abutment against the pressure sensor 181 after the prescribed time elapsed after the end of the printing operation, the solenoid 171 is not activated, that is, the label cutting section 153 does not displace itself (see Act 202 in the flow chart of FIG. 21).

Thus, even if the label pressing section 152 rises erroneously, resulting in the frame cover 154 coming into abutment against the pressure sensor 181, in the case where the label cutting section 153 should not be brought into abutment against the linerless label LL (that is, in a case other than the case where the label LB discharged through the label discharge port 114 should be cut), the solenoid 171 is not activated. That is, the entry of the label cutting section 153 into the guide passage 161 and abutment thereof against the linerless label LL is prevented.

Next, the user of the hand-held printer 101 moves the arm 402 while grasping the grip portion 104, thereby causing the printer 101 to move in such a manner as pulling the printer to the user side (rightward in FIG. 20) along the surface of the to-be-labeled object WK), as shown in FIG. 20C.

At this time, the adhesive surface LBa on the front end side of the label LB discharged through the label discharge port 114 adheres to the surface of the to-be-labeled object Wk, so that the position thereof is fixed. Further, the thermal head 113 and the platen 112 whose rotation has been stopped lock the linerless label LL including the label LB undrawably.

Therefore, if the user of the hand-held printer 101 moves the hand-held printer 101 in the pulling direction along the surface of the to-be-labeled object WK, the linerless label LL including the label LB discharged through the label discharge port 114 is pulled from both end sides. In the course of the movement of the hand-held printer 101 the linerless label LL having slits of the perforations becomes untolerable against pulling from end sides and the adhesive surface LBa is cut while allowing the label LB bonded to the to-be-labeled object WK to remain. In this way the label LB discharged through the label discharge port 114 is cut.

After the cutting of the label LB, the user of the hand-held printer 100 causes the printer to move in such a manner as pulling the printer to the user side while pressing down the printer against the to-be-labeled object WK. As a result, the label pressing section 152 presses down the label LB against the to-be-labeled object WK while sliding on the printing surface LBb, so that the adhesive surface LBa is sure to stick on the object WK.

After the sticking of the label LB on the to-be-labeled object WK, the user of the hand-held printer 101 causes the printer 101 to move away from the object WK, relieving the pressing force of the label pressing section 152 against the label LB. As a result, the torsion springs 156 which have accumulated a repulsive force revert to their original state and hence the pivotable member 151 pivots with the pivot shafts 155 as fulcrums and reverts to its original position.

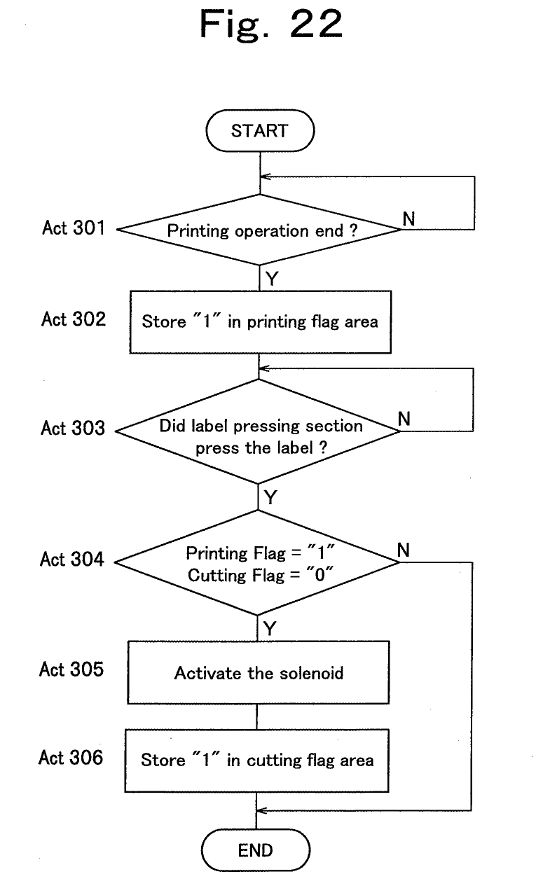

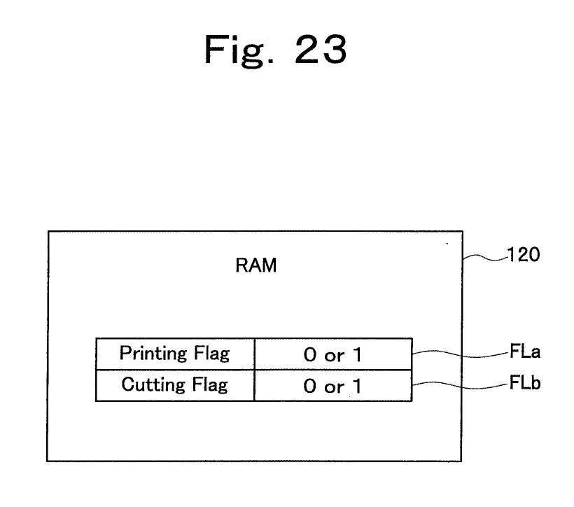

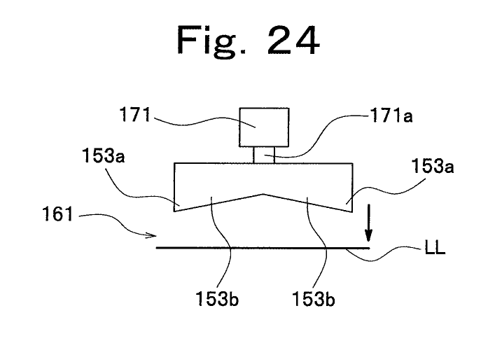

Now, with reference to FIGS. 22 and 23, a description will be given below about a processing which the CPU 117 executes at the time of sticking and cutting the label LB and which is different from the processing described above in connection with FIG. 21.

FIG. 22 is a flow chart showing an example of a flow of processing which the CPU 117 executes at the time of sticking and cutting the label LB. Upon determining the end of the printing operation performed by the thermal head 113 (Yes in Act 301), the CPU 117 causes “1” to be stored in a printing flag area FLa (see FIG. 23) of RAM 120 (Act 302).

FIG. 23 is a schematic diagram showing a data structure of the RAM 120. The RAM 120 forms a cutting flag area FLb in addition to the printing flag area FLa.

The printing flag area FLa stores “0” or “1” as Printing Flag. Printing Flag=“0” indicates that the printing operation based on the image data developed in the image memory 130 has not ended yet. Printing Flag=“1” indicates that the printing operation based on the image data developed in the image memory 130 has ended.

The cutting flag area FLb stores “0” or “1” as Cutting Flag. Cutting Flag=“0” indicates that the solenoid 171 is OFF, while Cutting Flag=“1” indicates that the solenoid 171 is ON.

The printing flag area FLa stores “0” at default setting as Printing Flag and the cutting flag area FLb stores “0” at default setting as Cutting Flag.

Referring back to FIG. 22, after allowing “1” to be stored in the printing flag area FLa (Act 302), the CPU 117 determines on the basis of the output provided from the pressure sensor 181 that the label pressing section 152 has pressed down the label LB (Yes in Act 303), then with reference to both printing flag area FLa and cutting flag area FLb the CPU 117 determines whether Printing Flag=“1” and Cutting Flag=“0” (Act 304).

The CPU activates the solenoid 171 via the solenoid controller 172 to displace the movable shaft 171a (Act 305) only when it determines in Act 304 that Printing Flag=“1” and Cutting Flag=“0” (Yes in Act 304). That is, the CPU 117 causes the movable shaft 171a to once assume an extended state from the retracted state and then again causes the movable shaft to revert to the retracted state. Further, the CPU 117 causes “1” to be stored as Cutting Flag in the cutting flag area FLb which stores “0” (Act 306).

When the CPU does not determine in Act 304 that Printing Flag=“1” and Cutting Flag=“0” (No in Act 304), it terminates the processing without activating the solenoid 171 (Act 305).

Then, when a printing operation is newly started (S103 in the flow chart of FIG. 7), the CPU 117 clears both printing flag area FLa and cutting flag area FLb to zero.

Even if the label pressing section 152 displaces itself erroneously, resulting in the pressure sensor 181 coming into abutment against the frame cover 154, prior to the printing operation (Printing Flag=“0”), the solenoid 171 is not activated because Printing Flag=“0” and Cutting Flag=“0” (No in Act 304). That is, the label cutting section 153 does not strike against the linerless label LL printing of which has not been ended.

Before start of the next printing, Printing Flag=“1” and Cutting Flag=“1” even after the end of sticking and cutting of label LB. Therefore, even if the label pressing section 152 should displace itself erroneously when the hand-held printer 101 is not in use, the solenoid 171 is not activated, that is, the label cutting section 153 does not come into abutment against the linerless label LL.

The shape of the label cutting section 153 is not limited to the one described above in connection with FIG. 18. For example, it may be such a shape as shown in FIG. 24 in which the label cutting section 153 is centrally depressed with respect to the guide passage 161 and has vertex portions 153a at both side ends thereof. The label cutting section 153 has side portions 153b extending from the vertex portions 153a toward the central part. First the vertex portions 153a strike against perforations LLa from the upper surface side. As a result, dot-like slits based on the shape of the vertex portions 153a are formed at both end portions of the perforations LLa. As the label cutting section 153 further gets into the guide passage 161, the oblique side portions 153b contiguous to the vertical portions 153a expand the slits gradually along the perforations LLa. In this way, slits are formed along the perforations LLa from both end portions toward the center.

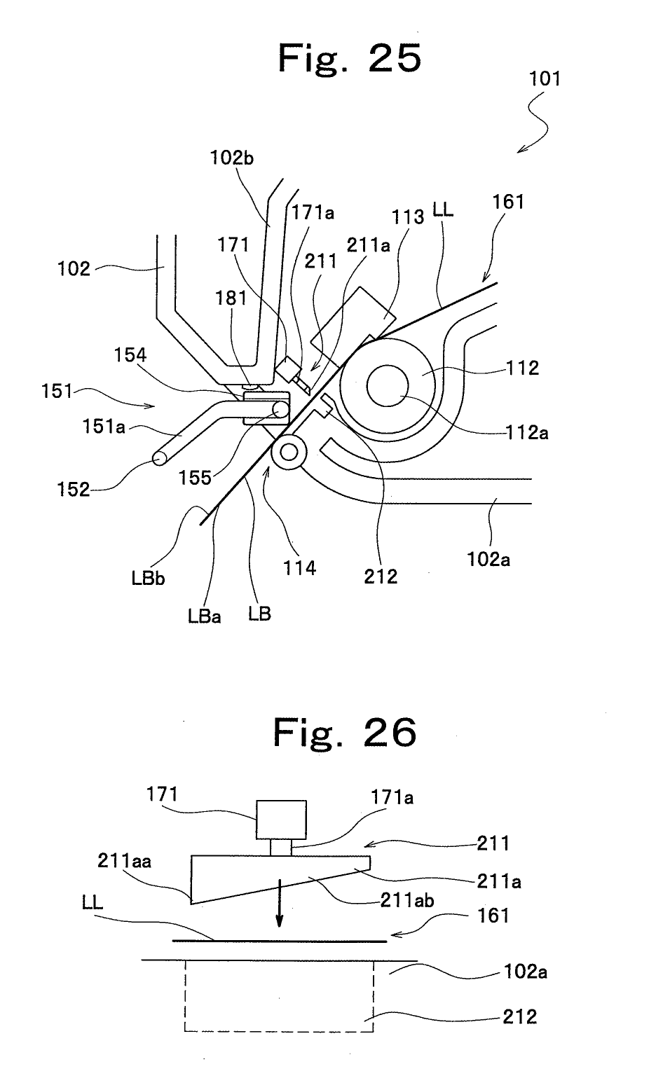

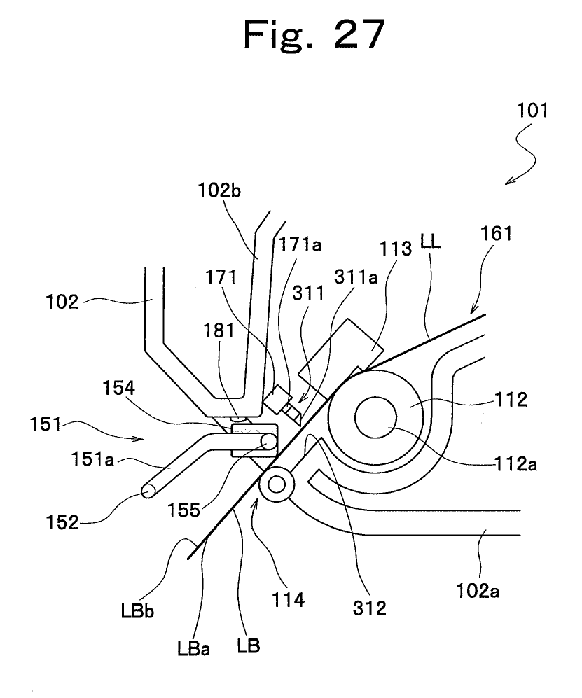

Next, with reference to FIGS. 25 and 26, a description will be given below about a hand-held printer 101 according to a still further embodiment of the present invention. A CPU 117 used in this hand-held printer 101 carries out the same processing as that described above in connection with FIGS. 7, 21 and 22.

FIG. 25 is a side view in longitudinal section showing the hand-held printer 101. FIG. 26 is a schematic diagram showing a label cutting section 211. The label cutting section 211 has a blade 211a. As shown in FIG. 25, the blade 211a is a sharp blade having a tip which is pointed at an acute angle when seen sideways. As shown in FIG. 26, the blade 211a has a shape which is pointed toward the guide passage 161. More specifically, the blade 211a has a vertex portion 211aa offset to one side of the guide passage 161 and a side portion 211ab which is an oblique edge portion contiguous to the vertex portion 211aa.

As shown in FIG. 25, at a position opposed to the tip of the blade 211a through the guide passage 161 the hand-held printer 101 has a receptacle slot 212, the receptacle slot 212 having a shape which permits the blade 211a to be received therein in an extended state of the movable shaft 171a of the solenoid 171. The lower unit 102a forms the receptacle slot 212.

When sticking the label LB discharged through the label discharge port 114 onto the to-be-labeled object WK, the user of the hand-held printer 101 presses the printer 101 against the object WK in a state in which the label pressing section 152 is in contact with the printing surface LBb. As a result, the pivotable member 151 undergoes an urging force from the to-be-labeled object WK and is displaced thereby, so that the frame cover 154 comes into abutment against the pressure sensor 181. Consequently, the solenoid 171 is activated (see Act 203 in the flow chart of FIG. 21 or Act 305 in the flow chart of FIG. 22) to extend the movable shaft 171a, so that the label cutting section 211 gets into the guide passage 161 and the blade 211a enters the receptacle slot 212.

In the course of entry of the blade 211a into the receptacle slot 212, first the vertex portion 211aa of the blade 211a pierces the linerless label LL to form a slit. As the blade 211a further gets into the receptacle slot 212, the oblique side portion 211ab expands the slit to cut the linerless label LL in the width direction. Since the blade 211a is shorter than the width of the linerless label LL, one or both ends of the linerless label LL become slit-free portions.

If the user of the hand-held printer 101 moves the printer 101 while pulling the printer to the user side along the surface of the to-be-labeled object Wk, the label LB is cut completely from the slit.

Since the blade 211a breaks through the linerless label LL forcibly to form a slit, it is possible to form a slit also in the portion free from perforations LLa of the linerless label LL or in a linerless label LL free from perforations LLa.

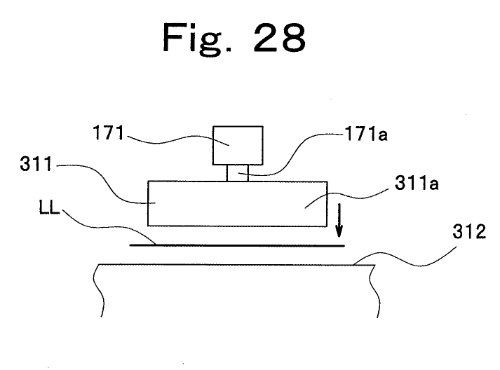

Next, with reference to FIGS. 27 and 28, a description will be given below about a hand-held printer 101 according to a still further embodiment of the present invention. A CPU 117 used in this hand-held printer 101 carries out the same processing as that described above in connection with FIGS. 7, 21 and 22.

FIG. 27 is a side view in longitudinal section showing the hand-held printer 101. FIG. 28 is a schematic diagram showing a label cutting section 311. The label cutting section 311 has a blade 311a whose tip is pointed at an acute angle when seen sideways. An abutment surface 312 is formed in the lower unit 102a at a position confronting the tip of the blade 311a.

For sticking the label LB discharged through the label discharge port 114 onto the to-be-labeled object WK, the user of the hand-held printer 101 presses down the printer 101 against the to-be-labeled object WK in a state in which the label pressing section 152 is in contact with the printing surface LBb of the label LB discharged through the label discharge port 114. As a result, the pivotable member 151 undergoes an urging force from the object WK and is displaced, so that the frame cover 154 comes into abutment against the pressure sensor 181. Consequently, the solenoid 171 is activated (see Act 203 in the flow chart of FIG. 21 or Act 305 in the flow chart of FIG. 22) to extend the movable shaft 171a and the label cutting section 311 gets into the guide passage 161, resulting in the blade 311a coming into abutment against the abutment surface 312.

Upon entry of the label cutting section 311 into the guide passage 161, the sharp blade 311a presses the linerless label LL present in the guide passage 161 against the abutment surface 312. As a result, the linerless label LL is cut along the blade 311a and a slit is formed in the width direction. Since the blade 311a is shorter than the width of the linerless label LL, one or both ends of the linerless label LL become slit-free portions.

Then, if the user of the hand-held printer 101 moves the printer 101 while pulling the printer to the user side along the upper surface of the to-be-labeled object WK, the label LB is cut completely from the slit.

According to the above embodiments, as described above, at the time of cutting the label LB discharged through the label discharge port 114, the user of the hand-held printer 101 does not require an operation entirely different from the operation of sticking the label LB onto the to-be-labeled object WK, namely, such an operation as cutting the label LB with the hand different from the hand which grasps the grip portion 104. Further, when cutting the label LB, the user of the hand-held printer 101 does not require any such operation as twisting the hand 401 that grasps the grip portion 104 or moving the arm 402 in the transverse direction.

For cutting the label LB discharged through the label discharge port 114 and sticking it to the to-be-labeled object WK, the user of the hand-held printer 101 performs only a series of operations involving pressing the label pressing section 152 (label pressing section 421) against the label LB and thereafter pulling the hand-held printer 101 to the user side.

That is, the user of the hand-held printer 101 can perform as a series of operations both the operation of cutting the linerless label LL and the operation of sticking the cut, individual label LB onto the to-be-labeled object WK.

Obviously, numerous modifications and variations of the present invention are possible in light of the above teachings. It is therefore to be understood that within the scope of the appended claims, the invention may be practiced otherwise than as specifically described herein.

What is claimed is:

1. A hand-held printer comprising:
a housing;
a receptacle section for storing a label;
a label discharge port positioned at a front end portion of the housing to let the label pass therethrough;
a guide passage providing connection between the receptacle section and the label discharge port and guiding the label;
a conveyance mechanism for conveying the label along the guide passage from the receptacle section and discharging the label through the label discharge port;
a control section for controlling a drive source of the conveyance mechanism;
a printing section for performing a printing operation in the guide passage;
a pivotable member positioned in the label discharge port and adapted to pivot, centered on an axis thereof extending in the width direction of the label discharged through the label discharge port, one end of the pivotable member being positioned outside the front end portion of the housing and an opposite end thereof being positioned inside the front end portion of the housing;
a label pressing section positioned on one end side of the pivotable member and pressing the label discharged through the label discharge port against a to-be-labeled object; and
a label cutting section positioned on the opposite end side of the pivotable member and adapted to strike against the label with a pivoting motion of the pivotable member induced by the pressing motion of the label pressing section to form a slit in the label.

2. The hand-held printer according to claim 1, wherein:
the receptacle portion stores a linerless label having perforations;
the control section causes the perforations of the linerless label discharged through the label discharge port to be located at a perforation position on a downstream side with respect to the printing section in the guide passage; and
the label cutting section has a pointed shape toward the guide passage and gets into the guide passage from an upper surface side with the pivoting motion of the pivotable member induced by the pressing motion of the label pressing section, a vertex portion of the label cutting section strikes against perforations located at the perforation position in the course of entry of the label cutting section into the guide passage to form a slit in the linerless label, and an oblique side portion contiguous to the vertex portion of the label cutting section subsequently strikes against unslit perforations adjacent to the slit perforations to expand the slit.

3. The hand-held printer according to claim 1, wherein:
the label cutting section has a blade of a pointed shape toward the guide passage and gets into the guide passage from an upper surface side with the pivoting motion of the pivotable member induced by the pressing motion of the label pressing section, a vertex portion of the blade pierces the label in the guide passage in the course of entry of the label cutting section into the guide passage to form a slit in the label, and a side portion of the blade contiguous to the vertex portion subsequently cuts the label to expand the slit.

4. The hand-held printer according to claim 1, further comprising an abutment surface against which the opposite end side of the pivotable member comes into abutment with the pivoting motion of the pivotable member, the abutment surface being positioned on a lower surface of the guide passage, wherein:
the label cutting section has a blade of a shape matching the abutment surface and gets into the guide passage with the pivoting motion of the pivotable member induced by the pressing motion of the label pressing section, the blade pressing the label against the abutment surface in the guide passage in the course of entry of the label cutting section into the guide passage to form a slit in the label.

5. The hand-held printer according to claim 1, further comprising a locking mechanism for undrawably locking the label discharged through the label discharge port.

6. A hand-held printer comprising:
a housing;
a receptacle section for storing a linerless label having perforations;
a label discharge port positioned at a front end portion of the housing to let the label pass therethrough;
a guide passage providing connection between the receptacle section and the label discharge port and guiding the label;
a conveyance mechanism for conveying the label along the guide passage from the receptacle section and discharging it through the label discharge port;
a printing section for performing a printing operation in the guide passage;
a control section for controlling a drive source of the conveyance mechanism so that the perforations of the linerless label discharged through the label discharge port are located at a perforation position on a downstream side with respect to the printing section in the guide passage;
a locking mechanism for locking the linerless label undrawably through the label discharge port, the linerless label being discharged through the label discharge port and with its perforations located at the perforation position;
a label pressing section positioned outside the front end portion of the housing and on an upper surface of the label discharge port, the label pressing section pressing the linerless label discharged through the label discharge port against a to-be-labeled object and imparting a longitudinal tension to the linerless label by movement along the pressed linerless label; and
a label cutting section disposed in the width direction of the linerless label discharged through the label discharge port, the label cutting section interfering with the perforation position in the guide passage from an upper surface side and having a pointed shape in the interfering direction, with a vertex portion thereof being adapted to strike against perforations of the linerless label on which the label pressing section exerts a tension to form a slit in the linerless label and with an oblique side portion thereof contiguous to the vertex portion being adapted to subsequently strike against unslit perforations adjacent to the slit perforations to expand the slit.

7. A hand-held printer comprising:
a housing;
a receptacle section for storing a label;
a label discharge port positioned at a front end portion of the housing to let the label pass therethrough;
a guide passage providing connection between the receptacle section and the label discharge port and guiding the label;
a conveyance mechanism for conveying the label along the guide passage from the receptacle section and discharging it through the label discharge port;
a printing section for performing a printing operation in the guide passage;
a label pressing section positioned on an upper surface side of the label discharge port and outside the front end portion of the housing and pressing the label discharged through the label discharge port against a to-be-labeled object;
a label pressing detecting section for detecting that the label pressing section has pressed the label discharged through the label discharge port and outputting the result of the detection;
a label cutting section positioned on the upper surface side of the label discharge port and inside the front end portion of the housing, the label cutting section being able to enter the guide passage and striking against the label in the course of the entry into the guide passage to form a slit in the label; and
a control section for controlling a drive source of the label cutting section in accordance with the detection output of the label pressing detecting section to make the label cutting section enter the guide passage.

8. The hand-held printer according to claim 7, wherein:
the receptacle section stores a linerless label having perforations;
the label cutting section has a pointed shape toward the guide passage and can get into the guide passage toward a perforation position located on a downstream side with respect to the printing section in the guide passage, a vertex portion of the label cutting section strikes against perforations of the linerless label located at the perforation position in the course of entry of the label cutting section into the guide passage to form a slit in the linerless label, and an oblique side portion contiguous to the vertex portion of the label cutting section subsequently strikes against unslit perforations adjacent to the slit perforations to expand the slit; and
the control section controls a drive source of the conveyance mechanism so that the perforations of the linerless label discharged through the label discharge port are located at the perforation position.

9. The hand-held printer according to claim 7, wherein the label cutting section has a blade of a pointed shape toward the guide passage, a vertex portion of the blade pierces the label in the guide passage in the course of entry of the label cutting section into the guide passage to form a slit in the label, and an oblique side portion of the blade contiguous to the vertex portion subsequently cuts the label to expand the slit.

10. The hand-held printer according to claim 7, further comprising an abutment surface positioned on a downstream side with respect to the printing section in the guide passage and on a lower surface side of the guide passage, wherein:
the label cutting section has a blade of a shape matching the abutment surface, the blade pressing the label in the guide passage against the abutment surface to form a slit in the label in the course of entry of the label cutting section into the guide passage.

11. The hand-held printer according to claim 7, wherein:
the control section drives the printing section to perform a printing operation on the basis of image data developed in an image memory, and only when the time elapsed after the end of the printing operation by the printing section is within a prescribed time, the control section controls a drive source of the label cutting section in accordance with the detection output of the label pressing detecting section to make the label cutting section get into the guide passage.

12. The hand-held printer according to claim 7, wherein:
the control section drives the printing section to perform a printing operation on the basis of image data developed in an image memory, makes control to store a fact of end of the printing operation by the printing section into a storage area upon end of the printing operation and store into the storage area a fact of entry of the label cutting section into the guide passage upon entry of the label cutting section into the guide passage performed by controlling a drive source of the label cutting section, and only when the storage area stores the fact of end of the printing operation and does not store the fact of entry of the label cutting section into the guide passage, the control section controls the drive source of the label cutting section to make the label cutting section get into the guide passage.

13. The hand-held printer according to claim 7, further comprising a locking mechanism for undrawably locking the label discharged through the label discharge port.
